(19) United States
(12) Patent Application Publication
(10) Pub. No.: US 2008/0004758 A1
(43) Pub. Date: Jan. 3, 2008

(54) Apparatus and method for tracking an orbital body relative to a planetary body using a single sensor

(75) Inventor: Hobson Lane, Hermosa Beach, CA (US)

Correspondence Address: POSZ LAW GROUP, PLC, 12040 SOUTH LAKES DRIVE, SUITE 101, RESTON, VA, 20191, US

(73) Assignee: Northrop Grumman Corporation, Los Angeles, CA (US)

(21) Appl. No.: 11/476,842

(22) Filed: Jun. 29, 2006

(51) Int. Cl. B64G 1/36

(52) U.S. Cl. 701/13; 701/207

(57) ABSTRACT

A system and method are disclosed for tracking a position of an orbital body relative to a planetary body. A processor (602) with memory (603) stores reference data associated with the planetary body. A single sensor (601) coupled to the processor, generates a scene frame (212) of a portion of the planetary body. A reference frame corresponding to the scene frame is retrieve from the memory. An image or one or more features of the scene frame is compared with a corresponding image or features associated with the reference frame. An attitude and/or an ephemeris of the orbital body is estimated by solving an equation set in open form or closed form based on the comparison and inputs such as rotation rate value and a linear velocity value associated with the orbital body.

### FIELD OF THE INVENTION

The present invention relates generally to space navigation, and more particularly to tracking a position of an orbital body relative to a planetary body by processing information collected from a single sensor.

### BACKGROUND

Spacecraft navigation typically involves determining, continuously tracking and correcting the attitude and position or ephemeris of the spacecraft or orbiting platform. Ideally, a spacecraft is equipped to navigate autonomously, without input from external sources. In order to facilitate autonomous spacecraft navigation, the spacecraft or orbiting platform must be provided with a set of sensors or sensors systems.

Various types of sensor systems have traditionally been used to provide autonomous navigation capabilities to spacecraft. Common sensors and sensor systems include sun sensors, horizon scanners, magnetometers, star sensors, gyroscopes, accelerometers, inertial measurement sensors, global positioning system receivers (GPSRs), and the like.

To determine the attitude and position or ephemeris of a spacecraft, the location and orientation of the spacecraft must be defined in terms of a frame of reference, such as with reference to a well known celestial body like a planet. Further, a frame of reference of the spacecraft, such as one or more vectors associated with the sensor system, center of mass or centroid of the spacecraft, or the like must also be established. The spacecraft reference vectors and thus the spacecraft position and attitude can then be established relative to a reference frame. Commonly used reference frames include Sun centered frames, Earth centered frames, celestial frames, or vectors or frames associated with the magnetic field of the Earth.

Once the reference frame is established, the orientation or attitude of the spacecraft in space can be determined with an attitude sensor usually with reference to a stable reference frame such as an earth centered earth fixed (ECEF) frame of reference. The ECEF frame of reference refers to a coordinate system centered on the World Geodetic System of global references revision 1984 (WGS-84) reference ellipsoid or similar reference, having the Z-axis nominally aligned with the Earth's spin axis, the X-axis through the intersection of the Prime Meridian in Greenwich, UK and the Equator, and the Y-axis rotated 90 degrees East of the X-axis about the Z-axis.

Similarly, the position or ephemeris of a spacecraft from a reference frame such as the ECEF frame or the relative frame of the center of the spacecraft can be determined by triangulating from several position vectors obtained from sensors. As described, conventional spacecraft use a number of different sensors for triangulation as well as added accuracy and redundancy. The suite of sensors is chosen to assure that the desired quantities can be calculated. Any single measurement of the line of sight from a satellite to another known location, restrains only 2 degrees of freedom, e.g. roll and pitch. Spacecraft attitude is a 3 degree of freedom (3-DOF) quantity, e.g. roll, pitch, and yaw. As a result, attitude determination requires the incorporation of more than one line of sight measurement to fully determine the attitude of a spacecraft.

Sun sensors are the most commonly used sensors and are primarily optical in nature. The sun's characteristics make it distinguishable from other objects and make sun sensor design simple and inexpensive. Analog sun sensors provide an output signal associated with an angle indicating a sun direction unit vector. Additional sensor measurements to calculate the 2-DOF unit vectors to other planetary or celestial bodies can be combined with the sun unit vector to determine the full 3-DOF attitude of the spacecraft relative to the desired reference frame.

Horizon scanners are also commonly used as sensors for directly determining 2 components of the full 3 degree-of-freedom (3-DOF) attitude of a spacecraft relative to the Earth. In many cases, the line of sight from a spacecraft to the Earth is of primary importance, particularly for weather satellites, terrestrial communications satellites, and the like. For low Earth orbit (LEO), Geosynchronous (GEO), or near Earth spacecraft, the Earth image occupies a significant portion sphere around the satellite. Therefore, because the Earth cannot be considered approximated as a point source, like the Sun, horizon detection is used to provide the additional precision required to with other sensor data and produce a full 3-DOF attitude estimate.

Horizon sensors typically detect a temperature contrast between cold space and the relatively warmer surface of the Earth or other planetary body and typically include four basic components: a scanner, an optical system, radiance detector, and a signal processor. Some horizon sensors are fixed to the body of the spinning spacecraft providing a scanning mechanism. The sensor can alternatively be attached to a momentum wheel which provides a scanning action. The optical system includes optics, a filter to select a spectral band, and a focusing mechanism for positioning the target image on a radiance detector, which detects the horizon based on light emissions and associated dark-to-light or light-to-dark transitions. The signal processor or signal processing electronics can be used to calculate various references such as time signal references used by the spacecraft attitude determination software to generate attitude data.

Problems arise however, in that such sensor systems typically require a relatively large array of hardware, some components of which can be comparatively massive. Since it is well appreciated that, in the context of spacecraft, excess mass is undesirable due to the cost and energy required to launch mass into orbit, massive sensors and sensor systems are undesirable. Additional electronic systems also require electrical power and thus present additional disadvantages. Further contributing to excess mass and power consumption is the redundant hardware required by many of the sensor systems or the practice of using a combination of sensor systems to track spacecraft position in addition to attitude. Redundant hardware or the use of a combination of different sensor systems is often required since many of the position calculations rely on triangulation or other methods which calculate position based on measurements from multiple sources. Such redundancy then disadvantageously requires duplication of identical hardware or the use of addition sensor systems simply to provide multiple points of reference and again contributes to an overall increase in mass, complexity, power, cost, and control requirements.

It would therefore be desirable for a sensor system that could reduce the payload requirements for a spacecraft by eliminating the need for redundant sensor hardware or the excess hardware associated with auxiliary sensor systems.

### SUMMARY OF THE INVENTION

Accordingly, the present invention provides an orbital platform such as a spacecraft with the ability to autonomously navigate or navigate through an external navigation control unit using a single on-board sensor.

An exemplary system can be used for tracking a position of an orbital body such as a satellite, spacecraft or the like, relative to a planetary body such as the Earth, the Moon, or the like. In accordance therefore with various exemplary embodiments, the system can include a processor such as a general purpose processor, a dedicated processor, a custom controller, application specific integrated circuit (ASIC) or the like. The processor is preferably equipped with a memory, which can be used for storing reference data associated with the planetary body. A single sensor can be coupled to the processor, which can generate a scene frame of a portion of the planetary body by operation of the sensor. For example, if the sensor is a camera, then the scene frame can be generated by an optical image capture operation. Alternatively, the scene frame can be generated or selected from a series of frames captured during a continuous streaming operation associated with a camera.

When a scene frame has been generated, the processor is configured to retrieve a reference frame of the reference data from the memory corresponding to the scene frame. An image or one or more features associated with the scene frame of the portion of the planetary body can be compared with a corresponding one of a second image and a second feature associated with the reference frame, recalled from memory or communicated from the ground. The comparison can be a correlation or other mathematical comparison as would be appreciated. Based on the comparison, one or both of an attitude and an ephemeris value associated with the orbital body can be estimated based on the comparison or correlation performed by the processor and can also be based on additional inputs such as previous estimates of the rotation rate value and a linear velocity value associated with the orbital body.

It will be appreciated that in accordance with various exemplary embodiments, the processor can be configured to estimate one or both of the attitude or ephemeris by solving an equation set associated with various position vectors in closed form. In addition, attitude rate and ephemeris velocity can also be calculated in closed form from a buffered historical set of attitude and position measurements.

The exemplary single sensor can be chosen from a number of different sensors operating across a wide continuum of different wavelengths including a camera, a video camera, an infrared sensor, an ultra-violet sensor, a forward looking infrared (FLIR) sensor, a radar sensor, a forward looking airborne radar (FLAR) sensor, a side looking airborne radar (SLAR) sensor, a radio frequency receiver, a microwave imager, and a laser radar sensor. It will be appreciated that while the present invention can provide a useful estimate of attitude and ephemeris with any one of the above sensors, the exemplary single sensor may nevertheless be deployed in an environment where several sensors are present. However, it should be recalled that in conventional spacecraft sensor systems, multiple sensors are required to provide an accurate attitude and ephemeris determination, while a single exemplary sensor in accordance with the invention can produce attitude and ephemeris estimates even in a multi-sensor environment.

In other embodiments, a method for navigating a spacecraft using a single sensor can be employed using, for example, various configurations of hardware. Such a method includes exemplary procedures such as generating a scene frame of a portion of a planetary body using the single sensor, identifying one or both of a feature or an image in the scene frame, which can then be compared or correlated to an image, feature or series of features from a reference frame, reference scene, or reference image, obtained from a database of scenes of the planetary body corresponding to the portion of the planetary body associated with the scene frame and a known pose or perspective and position in a known reference frame. One or both of an attitude or an ephemeris associated with the spacecraft and a frame of reference can be estimated based on the comparison of the identified features and images.

The estimating procedure preferably includes determining the attitude and the ephemeris based on solving a set of equations in closed form or by an iterative solution using well-understood optimal estimation filtering techniques, such as Kalman filtering. Inputs to the set of equations include the range and bearing to a reference location on the planetary body as well as the relative pose of that scene in the sensor frame. Other inputs required for optimal estimation filtering include previously estimated rotation rate vector or linear velocity vector associated with the spacecraft.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is a diagram illustrating an exemplary feedback control system for facilitating autonomous guidance navigation and control (GNC) in accordance with the invention.

FIG. 2 is a diagram illustrating a planetary body and an orbital body with various exemplary frames of reference associated therewith.

FIG. 3 is block diagram illustrating components of an exemplary closed form tracking system in accordance with the invention.

FIG. 4 is a block diagram illustrating components of an exemplary tracking system using an optimal estimator in accordance with the invention.

FIG. 5 is a flowchart illustrating an exemplary procedure for conducting navigation in accordance with the invention.

FIG. 6 is a diagram illustrating various hardware components of an exemplary navigation system in accordance with the invention.

### DETAILED DESCRIPTION OF THE PREFERRED EMBODIMENTS

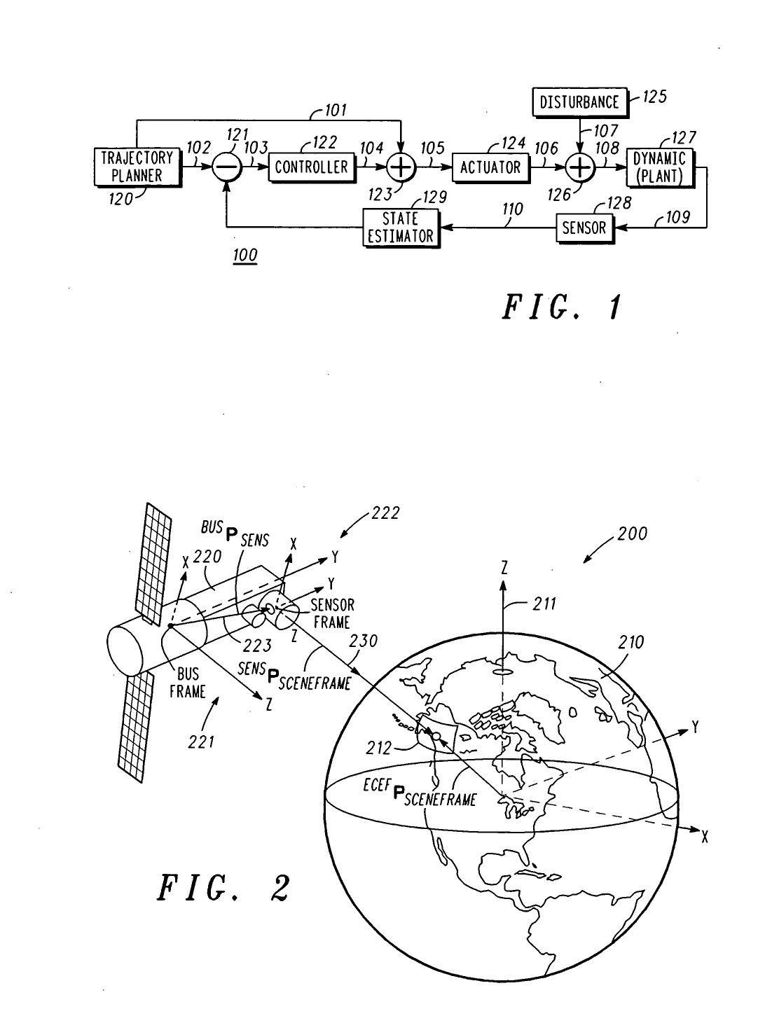

Referring now to the drawings in which like numbers reference like components, and in which a single reference number may be used to identify an exemplary one of multiple like components, FIG. 1 shows an exemplary feedback control system 100, which can be used for providing guidance, tracking navigation, and even correction or control. It will be appreciated that the present invention can be adapted for such use as correcting one of trajectory and attitude. However, the focus of the present invention is to provide information regarding the present attitude and ephemeris of a spacecraft, orbiting body or platform, or the like. In an exemplary application, a trajectory planner 120 can be used to provide the planned orbital path or attitude trajectory, for example, on mission requirements or exigencies arising during a spacecraft mission. Thus, the trajectory planner 120 can output a planned path signal 102 to a subtractor 121 which generates an error signal 103 from the output from a state estimator 120. The error output 103 can be input to a processor, ASIC, controller, or the like, such as controller 122 for generating a correction signal 104. The trajectory planner 101 can provide a feedforward signal 101, which can be mixed with the correction signal 104 at summer 123 which generates a composite correction signal 105.

The correction signal 105 can be output to an actuator 124 such as a thruster or some other device capable of changing the position of the spacecraft in multiple axes. The actuator can generate an actuation signal 106 which can be mixed with a disturbance input 107 at summer 126 to provide a corrected actuation signal 108 which can be input to the plant or orbital dynamic system 127. The orbital dynamic system 127 can provide a plant output 109 to sensor 128 to allow for corrections, for example, in the sensor frame of reference. The corrected sensor output 110 can be input to a state estimator 129 for generating an estimate of the spacecraft's current state. The sensor 128 can alternatively provide a raw output signal which can be input to the state estimator 129 independently of the plant output 109. It will be appreciated that the state estimator 129 then provides an estimate of the current state of the spacecraft such as the attitude and ephemeris including inputs such as rotation rate and linear velocity and inputting the state to the subtractor 121 completing the feedback loop. It will be appreciated that the spacecraft dynamics can include such values as the rotation rate and linear velocity can also include quantities such as the pitch, roll and yaw values for the craft. In simulation the plant 127 is implemented in mathematical form. In a physical instantiation, the plant 127 is the actual dynamics or motions experienced by the spacecraft as forces and torques are applied to it.

To better understand the operation of the single sensor of the present invention in an exemplary orbital scenario 200, reference can be made to FIG. 2. An orbital platform such as a spacecraft 220 can be placed into orbit around a planetary body 210 such as the Earth, for a variety of purposes as will be appreciated. The spacecraft 220 can be provided with at least a single sensor, but can have more sensors without departing from the invention since the single sensor of the present invention can be used independently to provide an accurate state estimate of the attitude and ephemeris of the spacecraft even when other sensors are present. In addition, the present invention may utilize multiple sensors as inputs in order to improve accuracy or reliability.

As described in the background section above, the ECEF frame of reference is a preferable reference, however it will be appreciated that any three dimensional orthogonal coordinate system reference can be used since virtually any orthogonal reference frame may be derived from another such as the ECEF reference frame by translation of the origin and rotation of the axes. Thus, an ECEF reference coordinate system 211 can be used to provide a reference frame for attitude and ephemeris calculations associated with the spacecraft 220. Correspondingly, the spacecraft 220 has two reference frames, one associated with the “bus” or the main body of the satellite or spacecraft, and one associated with the sensor. A bus reference frame 221 is located in the main body of the spacecraft 220 and a sensor frame 222 is located in the sensor, which may be offset slightly from the bus reference frame 221 so as to require its own reference frame. It will be appreciated however that in some instances, the bus frame and the sensor frame may coincide.

In order to carry out the invention in accordance with various embodiments, a scene frame 212, which can also be referred to as a swatch, swath, frame, patch, or the like, can be generated captured, or otherwise obtained depending on the type of sensor and stored in a memory. It will be appreciated that the scene frame 212 can be generated in a number of ways based on the type of sensor and typically represents a portion of the surface of the planetary body 210. For example, if the scene frame 212 is generated with a visible wavelength optical camera sensor, then the scene frame can represent a captured visual scene with images and features that can be used for comparison. If the scene frame 212 is generated with a radar sensor, then the scene frame 212 can represent a radar image with features associated with a radar return.

The following description will introduce notation that will be used throughout the present disclosure to describe various position vectors. The notation^{frame}P_{object} designates a position vector p of an object_{object} in terms of a coordinate system originating at a frame of reference^{frame}. Thus, a vector ^{BUS}p_{SENS} 223 designates a position vector of the sensor relative to the frame of reference of the bus. A vector ^{SENS}p_{SCENEFRAME} 230 designates a position vector of the sensor with regard to a sceneframe 212, which has a position associated with a position vector ^{ECEF}p_{SCENEFRAME}.

As will be appreciated, the above position vectors are to be determined and updated such that the spacecraft can be tracked. The vectors can be updated by estimating an attitude and ephemeris of the spacecraft during orbit as will be described hereinafter. As is shown and described in connection with FIG. 3, an exemplary scene comparison scenario 300 involves providing an estimate of one or both of an attitude or ephemeris using a closed form calculation of a set of equations describing the position vector of the sensor in terms of the orbiting platform or bus frame, the sensor frame, the ECEF frame and the sceneframe reference frame. A database 310 can contain stored data 301 in the form of actual images of the planetary body or a model of the planetary body such that reference images or scenes can be generated based on a particular position. As an actual scene frame is generated, for example in a camera 312, data 302 associated with the scene frame is output to an Earth tracker scene matching block 311. Stored data 301 and current state data 304 can be input to the scene matching block 311, which can generate an estimated state 303 which is input to the state propagator 312. Inertial measurement unit (IMU) 313 can provide inertial data 305. Alternatively anticipated orbital dynamics associated with the spacecraft can be used to formulate mathematical models to generate the inertial data 305 for utilization in the state propagator 312. The state propagator is used for making updates, for example to both the current state data 304 fed back to earth tracker 311 and the navigation data 306 sent to the guidance navigation and control (GNC) unit 314.

Once all of the vectors and rotation matrices required are generated by the scene matching block 311, a closed form solution can be accomplished by solving a system of equations such as in Equation (1). Multiple sets of vectors and rotation matrices are required to allow the closed form least squares solution of this 3-DOF vector equation.

$$\begin{matrix}{}_{}^{ECEF}{p}{}_{spcrft}^{} = {}_{}^{ECEF}{p}{}_{spcrft / sens}^{} + {}_{}^{ECEF}{p}{}_{sens / sceneframe}^{} + {}_{}^{ECEF}{p}{}_{sceneframe}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} ) + \\ {}_{}^{ECEF}{R}{}_{spcrft}^{} {}_{}^{spcrft}{p}{}_{sens}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} + \\ {}_{}^{sens}{R}{}_{spcrft}^{} {}_{}^{spcrft}{p}{}_{sens}^{} )\end{matrix} \qquad ( 1 )$$

where ECEF designates a planetary-body-centered, planetary-body-fixed frame of reference (in the present example the planetary body can be assumed to be Earth), ^{frame}p_{object} designates a position vector p of an object_{object} in terms of a coordinate system originating at a frame of reference^{frame}, spcrft designates the spacecraft, sens designates the single sensor, and sceneframe designates the scene frame. Uknown rotations matrices relative to ECEF, such as ^{ECEF}Rₛₑₙₛ, are obtained by cascading or premultiplying known or measured rotation matrices such as the pose of the scene frame relative to the sensor, which can be measured, for example, during the scene matching process, and the pose of the scene frame relative to the reference frame, which is known and stored during creation of the scene frame database.

As can be seen, the solution to Equation (1) will produce a solution for ^{ECEF}p_{spacecraft}, yielding a value for the position vector of the spacecraft relative to the ECEF frame of reference. It will be appreciated that the position vector ^{ECEF}p_{spacecraft} can be solved with different sets of equations based, for example, on other frames of reference or the like.

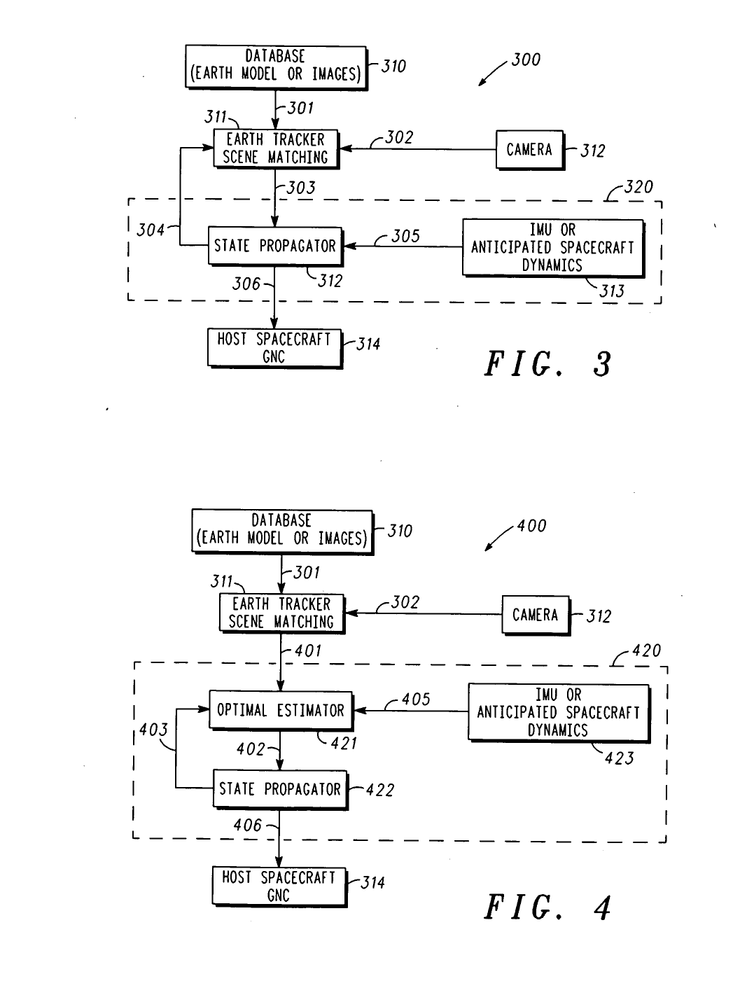

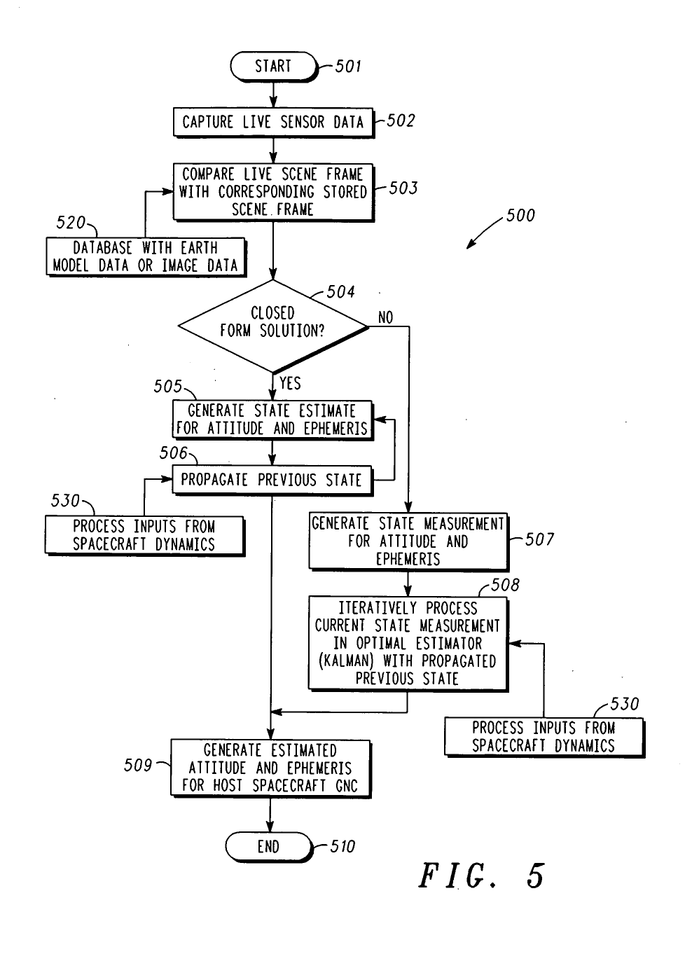

In accordance with another exemplary embodiment, an iterative solution can be calculated and the estimate of the ^{ECEFP}p_{spacecraft} position vector and ^{ECEF}R_{spacecraft} attitude can be refined over time. With reference to FIG. 4, an alternative exemplary scene comparison scenario 400 involves providing an estimate of one or both of a position or ephemeris using an open form calculation of a set of equations describing the position vector of the sensor in terms of the orbiting platform or bus frame, the sensor frame, the ECEF frame and the sceneframe reference frame. As previously described, database 310 can contain stored data 301. As an actual scene frame is generated, for example in a camera 312, data 302 associated with the scene frame is output to an Earth tracker scene matching block 311.

Stored data 301 and current state data 304 can be input to the scene matching block 311, which can generate an estimated state 401 which is input to the state propagator 421. It will be appreciated that unlike the previous example, scene matching block 311 generates a difference value between the scene frame data, such as data 302 and the stored data 301. Inertial measurement unit (IMU) 423 can provide inertial data 405 or anticipated orbital dynamics associated with the spacecraft to an optimal estimator 421. In addition, the state propagator 422 can provide state data 403 to the optimal estimator 421. The optimal estimator 421 can compare the estimated state 401, which can include the difference between the actual scene and the stored scene, the inertial data 405 and the state data 403 and provide, for example, an iterative solution to Equation (1). Using, for example, Kalman filtering or the like, an improved state estimate 402 can be generated and input to the state propagator 422 which outputs the current state estimate to the guidance navigation and control (GNC) unit 314.

The various open form and closed form procedures as describe above can be further described in connection with an exemplary procedure 500 shown in FIG. 5. It will be appreciated that the exemplary procedure can be implemented on a computer, processor, controller, or the like capable of deployment on a satellite or other orbital platform. After start at 501, which can include initialization, reset, power-up or the like, the sensor can be initialized and powered up as would be appreciated and live sensor data can be captured or otherwise generated at 502. The live sensor data, such as a scene frame can be compared such as by correlation to data from a repository of stored data at 520 or data generated from a model or the like. If it is determined at 504 that a closed form solution is desired, a state estimate for one or both of attitude or ephemeris can be generated at 505. The previous state can be propagated at 506 along with inputs from a spacecraft dynamics unit at 530 and an estimated attitude and/or ephemeris can be generated at 509.

It will also be appreciated that in some embodiments, the comparison between the captured or generated scene frame and the stored scene frame can be made using a hierarchical matching procedure. In such a procedure a scene frame can be divided into a series of low resolution image regions, which can be correlated initially against the corresponding portions of the stored scene frame to determine which of the low resolution image regions can be explored at higher resolution. As the hierarchical procedure proceeds, unproductive branches can be pruned as would be appreciated by one of ordinary skill.

If the closed for solution is not desired at 504, and an iterative or open form solution is desired, a state measurement including attitude and/or ephemeris can be generated at 507 whereupon iterative processing can be conducted on the measurement and a propagated state, using an estimation procedure such as a Kalman filtering procedure as will be appreciated by one of ordinary skill. Inputs from spacecraft dynamics 530 can also be included in the processing to correct for any drifting that may occur during processing. Again, an estimated attitude and/or ephemeris can be generated at 509. While the procedure is indicated as ending at 510, it will be appreciated that the procedure can be conducted continuously during spacecraft operation, or even during simulated flight, testing or the like.

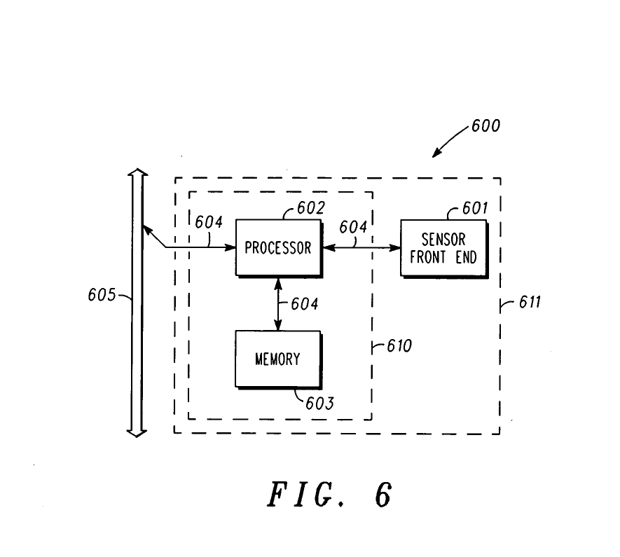

The exemplary sensor of the present invention as noted can include a variety of different sensor types as described above. A hardware scenario 600 shown in FIG. 6 includes various hardware components that may be required to conduct various navigation procedures as describe herein. It will be appreciated that depending on the sensor type, a sensor front end unit 601 can include the necessary hardware to produce sensor data which can be placed on a data bus 604. For example, if the sensor is a radar unit, the sensor front end unit 601 may include a transmitter and receiver and processor for sending a radar pulse receiving a return and translating the return into image data. Other sensors may be passive such as a camera sensor and may include an optical unit and a conversion unit to convert the optical data into image data. In an exemplary camera implementation, a simple low cost camera can be used such as a common 256 by 256 element array with a 300 field of view (FOV) resulting in a 0.5 km field at low earth orbit altitudes. In higher performance systems a 1024×1024 element resolution can be used.

The sensor data can be input to a processor 602 over the data bus 604 for processing in accordance with various procedures as described herein. The processor 602 can include a processor operating on the order of 10 MIPS resulting in an update latency for attitude and ephemeris calculations of around 5 seconds based on a projected computational load requirement of 50 million instructions. The calculation of course would be faster on a faster processor and slower on a slower processor. For example on a 300 MIPS processor, a 100 ms latency can be expected. On a 2.2 MIPS processor as is commonly deployed, a 30 second latency can be expected. It will further be appreciated that the computational requirements are dramatically greater for determining ephemeris and attitude when neither are previously known to any accuracy. For example, in a typical four region four branch hierarchical search of the entire Earth, with unknown initial attitude and ephemeris, a 10 MIPS processor may take as much as 2 hours for a complete solution, while a 300 MIPS processor could likely conduct the same search in less than 1 minute.

The processor 602 can be coupled to a memory 603 over the data bus 604, which can also be coupled to a main data bus 605 for connecting to other portions of the satellite platform such as a communications link. The communication link is not shown since it is well known in the art. In other exemplary embodiments, it will be appreciated that information such as stored information or model information associated with the planetary body can be provided remotely over the communications link, such as from a ground station or other orbiting platform without departing from the invention. In the present exemplary embodiment, the memory 603 is preferably on the order of 200 MB to support a scene resolution of 500 m. It is known that the Earth surface area is around 5×10¹⁴ m² or 5×10⁸ km² however it is 83% featureless therefore the storage requirement are based on feature density across the surface. Planetary bodies with additional featured surfaces and/or larger surfaces would typically require greater storage capacity. In addition, systems requiring greater attitude or ephemeris positioning accuracy could require greater storage capacity as well.

The present examples and embodiments are to be considered as illustrative and not restrictive and the invention is not to be limited to the details given herein, but may be modified within the scope and equivalence of the appended claims.

What is claimed is:

1. A system for tracking a position of an orbital body relative to a planetary body, the system comprising:
a processor having a memory for storing reference data associated with the planetary body; and
a single sensor coupled to the processor, the sensor configured to generate a scene frame of a portion of the planetary body;
wherein the processor is configured to:
(a) retrieve a reference frame of the reference data from the memory corresponding to the scene frame;
(b) compare one of a first image and a first feature associated with the scene frame of the portion of the planetary body with a corresponding one of a second image and a second feature associated with the reference frame; and
(c) estimate one of an attitude and an ephemeris associated with the orbital body based on the comparison performed by the processor in (b) and one of a rotation rate value and a linear velocity value associated with the orbital body.

2. The system according to claim 1, wherein the processor is configured to estimate the one of the attitude and ephemeris by solving an equation set in closed form.

3. The system according to claim 1, wherein the processor is configured to estimate the one or more of the attitude and ephemeris by solving an equation set including:
$$\begin{matrix}{}_{}^{ECEF}{p}{}_{spcrft}^{} = {}_{}^{ECEF}{p}{}_{spcrft / sens}^{} + {}_{}^{ECEF}{p}{}_{sens / sceneframe}^{} + {}_{}^{ECEF}{p}{}_{sceneframe}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} ) + \\ {}_{}^{ECEF}{R}{}_{spcrft}^{} {}_{}^{spcrft}{p}{}_{sens}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} + \\ {}_{}^{sens}{R}{}_{spcrft}^{} {}_{}^{spcrft}{p}{}_{sens}^{} )\end{matrix}$$
where:
ECEF designates a planetary-body-centered-planetary-body-fixed frame of reference, the planetary body including Earth,
^{frame}p_{object} designates a position vector p of an object_{object} in terms of a coordinate system originating at a frame of reference^{frame},
spcrft designates the orbital body,
sens designates the single sensor, and
sceneframe designates the scene frame.

4. The system according to claim 1, wherein the processor is further configured to:
update the estimate of the one of the attitude and the ephemeris associated with the spacecraft by repeating (a), (b) and (c); and
perform (c) using the updated estimate and an optimal estimation procedure.

5. The system according to claim 4, wherein the optimal estimation procedure includes a Kalman filtering procedure.

6. The system according to claim 1, wherein the processor is configured to perform (b) by using one of a hierarchical matching procedure and a correlation procedure.

7. The system according to claim 1, wherein the single sensor includes one of a camera, a video camera, an infrared sensor, an ultra-violet sensor, a forward looking infrared (FLIR) sensor, a radar sensor, a forward looking airborne radar (FLAR) sensor, a side looking airborne radar (SLAR) sensor, a radio frequency receiver, a microwave imager, and a laser radar sensor.

8. A navigation system for tracking a spacecraft comprising:
a single sensor coupled to the spacecraft, the single sensor configured to generate a scene frame of a portion of a planetary body;
an external unit storing a reference frame associated with the planetary body; and
a communications link between the spacecraft, the single sensor and the external unit,
wherein one of an attitude and an ephemeris is estimated based on the scene frame and a reference frame stored in the external unit.

9. The navigation system according to claim 8, wherein the external unit includes one of a ground-based unit and an orbital unit, the external unit further including a processor having a memory storing reference data including the reference frame associated with the planetary body; and
wherein the processor is configured to:
(a) retrieve the reference frame from the reference data the reference frame corresponding to the scene frame;
(b) correlate one of a first feature and a first image associated with the scene frame of the portion of the planetary body with a corresponding one of a second feature and a second image associated with the reference frame; and
(c) estimate one of an attitude and an ephemeris associated with the spacecraft based on the correlation performed by the processor in (b) and one of a rotation rate value and an linear velocity value associated with the spacecraft.

10. The navigation system according to claim 9, wherein the processor is configured to estimate in (c) by solving a set of equations in closed form.

11. The navigation system according to claim 9, wherein the processor is configured to estimate in (c) the one or more of the attitude and ephemeris by solving an equation set including:
$$\begin{matrix}{}_{}^{ECEF}{p}{}_{spcrft}^{} = {}_{}^{ECEF}{p}{}_{spcrft / sens}^{} + {}_{}^{ECEF}{p}{}_{sens / sceneframe}^{} + {}_{}^{ECEF}{p}{}_{sceneframe}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} ) + \\ {}_{}^{ECEF}{R}{}_{spcrft}^{} {}_{}^{spcrft}{p}{}_{sens}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} + \\ {}_{}^{sens}{R}{}_{spcrft}^{} {}_{}^{spcrft}{p}{}_{sens}^{} )\end{matrix}$$
where:
ECEF designates a planetary-body-centered-planetary-body-fixed frame of reference, the planetary body including Earth,
^{frame}p_{object} designates a position vector p of an object object in terms of a coordinate system originating at a frame of reference^{frame},
spcrft designates the orbital body,
sens designates the single sensor, and
sceneframe designates the scene frame.

12. The navigation system according to claim 9, wherein the processor is further configured to:
update the estimate of the one of the attitude and the ephemeris associated with the spacecraft by repeating (a), (b) and (c); and
perform (c) using the updated estimate and an optimal estimation procedure.

13. The navigation system according to claim 12, wherein the optimal estimation procedure includes a Kalman filtering procedure.

14. The navigation system according to claim 9, wherein the processor is further configured to:
divide the scene frame and the reference frame into regions;
correlate a first region of the scene frame of the portion of the planetary body with corresponding region of the reference frame; and
increase a resolution of the first region and the corresponding region if the correlation is above a threshold value and prune the region if the correlation is below the threshold using a hierarchical matching procedure.

15. The navigation system according to claim 9, wherein the single sensor includes one of a camera, a video camera, an infrared sensor, an ultra-violet sensor, a forward looking infrared (FLIR) sensor, a radar sensor, a forward looking airborne radar (FLAR) sensor, a side looking airborne radar (SLAR) sensor, a radio frequency receiver, a microwave imager, and a laser sensor.

16. A method for navigating a spacecraft using a single sensor, comprising:
generating a scene frame of a portion of a planetary body using the single sensor;
identifying one of a first feature and a first image in the scene frame;
correlating the identified one of the first feature and first image from the scene frame with a corresponding one of a second feature and a second image from a reference frame of the planetary body corresponding to the portion of the planetary body; and
estimating one of an attitude and an ephemeris associated with the spacecraft and a frame of reference based on the correlating the identified one and the corresponding one.

17. The method according to claim 16, wherein the estimating includes determining the one of the attitude and the ephemeris associated with the spacecraft based on solving a set of equations in closed form using as inputs the correlation and one of a rotation rate value and a linear velocity value associated with the spacecraft.

18. The method according to claim 17, wherein the estimating the one of the attitude and ephemeris includes solving an equation set including:
$$\begin{matrix}{}_{}^{ECEF}{p}{}_{spcrft}^{} = {}_{}^{ECEF}{p}{}_{spcrft / sens}^{} + {}_{}^{ECEF}{p}{}_{sens / sceneframe}^{} + {}_{}^{ECEF}{p}{}_{sceneframe}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} ) + \\ {}_{}^{ECEF}{R}{}_{spcrft}^{} {}_{}^{spcrft}{p}{}_{sens}^{} \\ = {}_{}^{ECEF}{p}{}_{sceneframe}^{} + {}_{}^{ECEF}{R}{}_{sens}^{} \cdot ( - {}_{}^{sens}{p}{}_{sceneframe}^{} + \\ {}_{}^{sens}{R}{}_{spcrft}^{} {}_{}^{spcrft}{p}{}_{sens}^{} )\end{matrix}$$
where:
ECEF designates a planetary-body-centered-planetary-body-fixed frame of reference, the planetary body including Earth,
^{frame}p_{object} designates a position vector p of an object_{object} in terms of a coordinate system originating at a frame of reference^{frame},
spcrft designates the orbital body,
sens designates the single sensor, and
sceneframe designates the scene frame.

19. The method according to claim 17, wherein the determining the one of the attitude and ephemeris includes:
generating an additional scene frame using the single sensor;
repeating the identifying and the comparing; and
updating the estimating of the one of the attitude and ephemeris using an optimal estimation procedure on a result obtained by repeating the identifying and the comparing.

20. The method according to claim 17, wherein the optimal estimation procedure includes a Kalman filtering procedure.

21. The method according to claim 16, wherein the single sensor includes one of a camera, a video camera, an infrared sensor, an ultra-violet sensor, a forward looking infrared (FLIR) sensor, a radar sensor, a forward looking airborne radar (FLAR) sensor, a side looking airborne radar (SLAR) sensor, a radio frequency receiver, a microwave imager, and a laser sensor.
